(19) United States
(12) Patent Application Publication
(10) Pub. No.: US 2003/0143314 A1
(43) Pub. Date: Jul. 31, 2003

(54) Process for manufacturing individually quick-freeze-formed Calamari squid rings

(76) Inventors: Michael G. Smith, Portsmouth, NH (US); Christian T. Callahan, Portsmouth, NH (US)

Correspondence Address: Richard C. Litman, LITMAN LAW OFFICES, LTD., P.O. Box 15035, Arlington, VA, 22215, US

(21) Appl. No.: 10/348,021

(22) Filed: Jan. 22, 2003

Related U.S. Application Data
(60) Provisional application No. 60/349,373, filed on Jan. 22, 2002.

(51) Int. Cl. A23L 1/325

(52) U.S. Cl. 426/643

(57) ABSTRACT

A manufacturing process for packaging fresh frozen Calimari squid rings comprising the process steps of placing of fresh flattened Calamari squid slices on molds having a vertical pin to open up the squid slices, freezing the open squid slices on hexagonally arranged molds on trays at 5-15° F., removing the frozen open squid slices from the molds, refreezing the open squid slices at 20° F., and packaging the open squid slices in sealed containers selected from either paper boxes or plastic bags.

### CROSS-REFERENCE TO RELATED APPLICATION

This application claims the benefit of U.S. Provisional Patent Application Serial No. 60/349,373, filed Jan. 22, 2002.

### BACKGROUND OF THE INVENTION

1. Field of the Invention

The present invention relates generally to manufacturing frozen seafood. More specifically, the invention is a conveyor process of manufacturing quick-freeze-formed Calamari squid rings.

2. Description of Related Art

The related art of interest describes various methods of producing fish products, but none discloses the present invention. There is a need for making available frozen, sliced and open squid rings for ease in eating raw or cooking as well as decreasing the manufacturing cost by increasing the yield by weight of the food product. The related art is as follows.

U.S. Pat. No. 2,822,274 issued on Feb. 4, 1958, to Beverly E. Williams describes a process for the preparation of squid fillets, seasoning, breading, and freezing the breaded fillet.

U.S. Pat. No. 3,034,906 issued on May 15, 1962, to Beverly E. Williams describes a process for skinning squids for the preparation of squid fillets.

U.S. Pat. No. 3,151,991 issued on Oct. 6, 1964, to Michael E. Evans et al. describes a method for cutting −18° C. frozen fish by a mechanical cutter.

U.S. Pat. No. 3,593,370 issued on Jul. 20, 1971, to James M. Lapeyre describes a method of butchering whole frozen tuna.

U.S. Patent No. 4,436,759 issued on March 13, 1984, to David M. Trilling et al. describes shaped gelled food products manufactured from comminuted, granulated or chopped foodstuffs such as vegetables, fruits, meats, and fish, and the manufacturing process.

U.S. Pat. No. 4,622,234 issued on Nov. 11, 1986, to Minoru Okada describes a process for preparing abalone and fish meat products by grinding with salt and the like to prepare a paste, frozen and heated to sterilize.

U.S. Pat. No. 4,701,339 issued on Oct. 20, 1987, to Jean-Louis Leuba et al. describes a method for dissolving squid membranes.

U.S. Pat. No. 4,859,478 issued on Aug. 22, 1989, to Jose M. I. Castro describes a process for manufacturing reconstituted squid in the form of rings. The eatable squid parts are washed and minced together at below zero temperatures. The pieces are compacted into ring-shaped molds. The rings are dipped into batter or bread crumbs and frozen.

U.S. Pat. No. 5,124,168 issued on Jun. 23, 1992, to Terri W. McMillin et al. describes a pasta product and the method of making it by mixing dried ingredients of flour, a monoglyceride with dried egg whites, olive oil, water, and flavoring compounds, and extruding the mixture under pressure.

U.S. Pat. No. 5,285,719 issued on Feb. 15, 1994, to David H. McFadden et al. describes a rapid frozen food thawing system.

U.S. Pat. No. 5,797,271 issued on Aug. 25, 1998, to Robert J. Darigo et al. describes a mobile brine tank quick-freezing system and method.

U.S. Pat. No. 5,817,353 issued on Oct. 6, 1998, to Nicholas A. Guarino describes a process and flat pack vacuum pallet packaging for shellfish and the like.

U.S. Pat. No. 5,955,131 issued on Sep. 21, 1999, to Yoshiyuki Fujita et al. describes a method of sandwiching soft and smooth fluid shrimp as a flat shape with uniform thickness.

U.S. Pat. No. 6,096,361 issued on Aug. 1, 2000, to Akiyoshi Yamane et al. describes a method for non-frozen preservation of fish and shellfish at a temperature below the freezing point.

Japan Patent Application No. 58-31967 published on Feb. 24, 1983, for Sueo Takahashi et al. describes the preparation of ring-shaped cuttlefish pieces by kneading the arms and fins with salt to obtain a meat paste, mixing the paste with seasoned chopped and cooked squid, and punching into rings.

Japan Patent Application No. 58-40076 published on Mar. 8, 1983, for Jiyun Irie et al. describes a method for preventing the sticking or deformation of canned cuttlefish cut in round slices by the heat and pressure of a retort after packing with a meat by dipping the round slices in an aqueous proteinic denaturing agent, i.e., alum or tannic acid, rinsing off the agent, packing with a meat, mixed with edible oil and seasoning, sealing in a can, and sterilizing the canned cuttlefish under pressure in a retort.

Japan Patent Application No. 3-10661 published on Jan. 18, 1991, for Shinichi Goto describes a preparation of ring-shaped torn and roasted cuttlefish by roasting cleaned but uncut cuttlefish between hot plates, rolling, and tearing the product.

Japan Patent Application No. 4-108364 published on Apr. 9, 1992, for Yutaka Kudo et al. describes a processed cuttlefish product by grinding the trunk meat, blending with wheat flour, starch and calcium hydroxide, and forming the blend into ribbons or rings.

Japan Patent Application No. 10-113150 published on May 6, 1998, for Koji Nakamura describes a process of cutting live squids into a continuous thin slice.

None of the above inventions and patents, taken either singly or in combination, is seen to describe the instant invention as claimed.

### SUMMARY OF THE INVENTION

The invention is the process of preparing Calamari squid rings which are quickly frozen, natural, raw, and open rings. Calamari squid rings for consumption are conventionally prepared by removing the body and cleaning, skinning, removing the wings, washing, slicing the body into parallel strips, and coating the slices with bread crumbs and the like. However, this method is labor intensive and the product is not frozen. Another known process comprises the processing of frozen cleaned squid which is further processed, and is still labor intensive and costly. Yet another process comprises the blanching or partially cooking the squid rings which results in a significant loss of moisture in the final product.

In the present invention, the Calamari squids are cleaned and hand-cut to remove the tentacles, head, wings, and the entrails. The cleaned squid tubes are cut into parallel rings and placed on mold trays having an upstanding pin in an open condition for prefreezing at 5-15° F. in a prefreezer tunnel apparatus. The squid rings are removed from the trays, and the loose rings frozen again at 20° F. in another freezer tunnel apparatus. The squid rings are packaged in a paper box or in a sealed plastic bag for storage or sale. The mold trays are recycled by washing, placed on carts and moved to the squid ring forming station.

Thus, an economical manufacturing conveyor process for producing fresh Calamari squid rings in packaged form for the consumer is disclosed.

Accordingly, it is a principal object of the invention to provide a manufacturing process for producing quickly frozen open Calamari squid rings.

It is another object of the invention to produce quickly frozen, open and natural Calamari squid rings by a continuous assembly line process.

It is a further object of the invention to produce quickly frozen, open and natural Calamari squid rings by utilizing two freezing steps in the manufacturing process.

Still another object of the invention is to produce quickly frozen, open and natural Calamari squid rings for sale and consumption in packaged form.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

BRIEF DESCRIPTION OF THE DRAWINGS

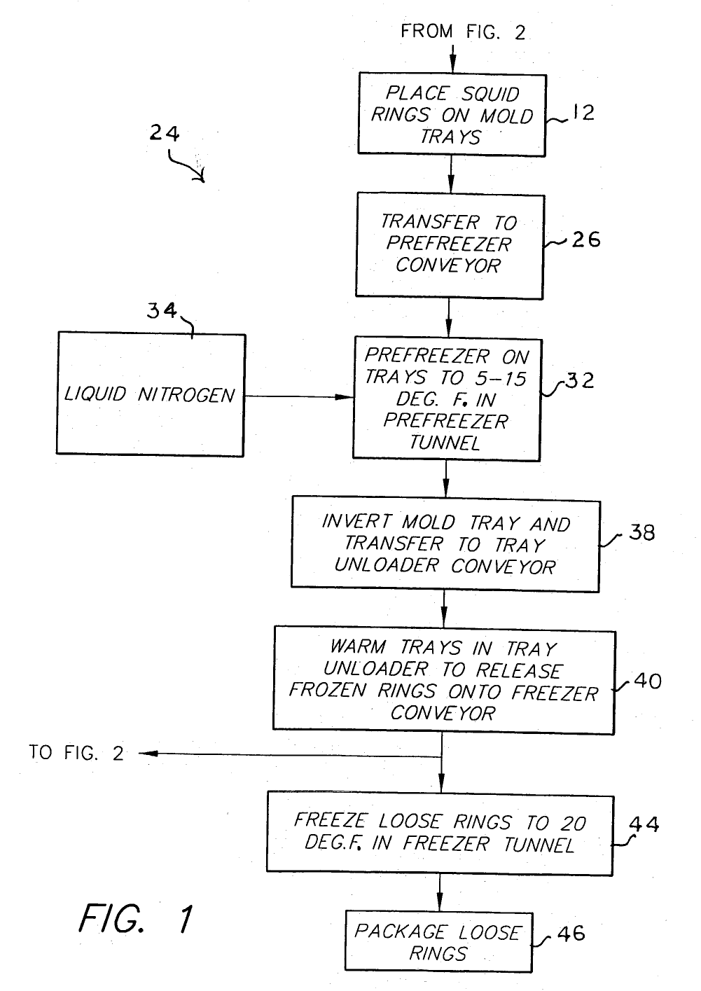

FIG. 1 is a schematic diagram of a first portion of a process for preparing freeze-dried Calamari squid rings.

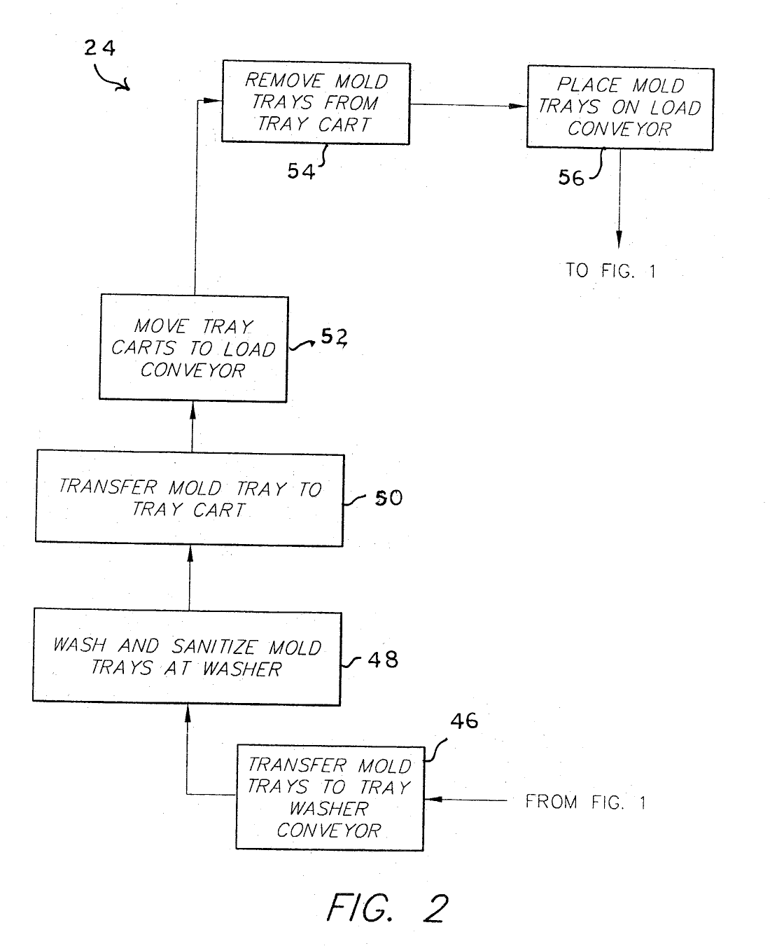

FIG. 2 is a schematic diagram of a second portion of a process for preparing freeze-dried Calamari squid rings to recycle empty mold trays to the squid loading stage.

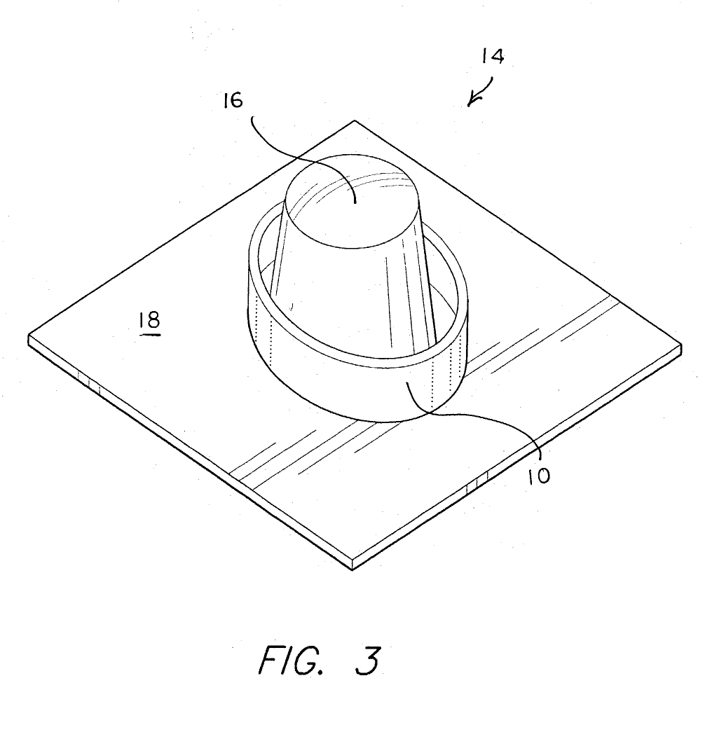

FIG. 3 is a perspective view of a mold tray with one squid ring.

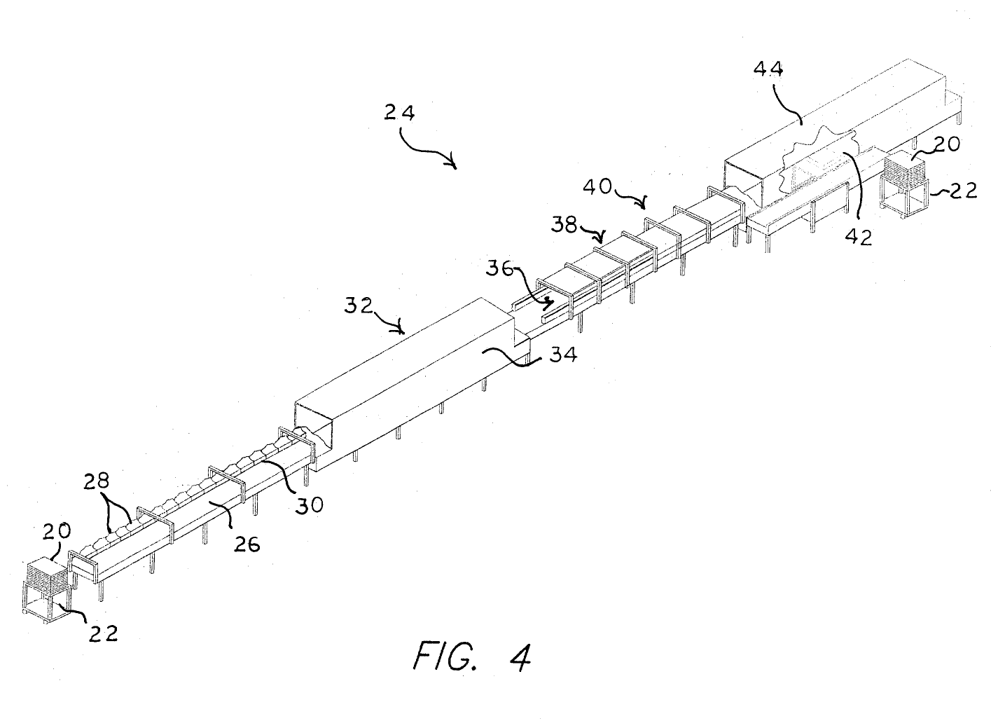

FIG. 4 is a perspective view of the assembly line for manufacturing the freeze-dried Calamari squid rings.

Similar reference characters denote corresponding features consistently throughout the attached drawings.

### DETAILED DESCRIPTION OF THE PREFERRED EMBODIMENT

The present invention is directed to a manufacturing method illustrated in FIGS. 1 through 4 for producing fresh freeze-dried Calamari squid rings. In FIG. 1 the process begins with the placement of a freshly frozen opened Calimari squid ring 10 as a first process step 12 on a mold 14 over a pin 16 having a diameter decreasing in width from the flat square base 18 as shown in FIG. 3 to maintain the squid ring 10 in an open position throughout the process. As schematically depicted in either FIGS. 1 (block diagram) or 4 (assembly line), empty molds 14 are loaded on trays 20 in a hexagonal pattern as a group of six mold trays 14 in a tray 20 on a tray cart 22 for delivery to the process line 24 to be placed on load conveyor line 26. A worker will place a tray 20 every 7.5 seconds on the load conveyor line 26. The loading step can be automated as an alternative using conventional pick and place devices. Alternatively, the loading process step can be performed at a separate location. Boxes 28 of graded squid slices 10 are provided coaxially on continuous racks 30 for workers to manually load each mold 14 with a squid slice 10 on the trays 20. The loaded trays 20 are carried on the conveyor line 26 to a prefreezer tunnel 32 maintained at 5-15° F. by either impinging liquid nitrogen or carbon dioxide snow 34. Ambient conditions may require adjustment of the temperature in the pre-freezer tunnel 32. A worker removes each frozen squid slice 10 containing tray 20 from the tray transfer conveyor line 36 and inverts the loaded trays 20 end-to-end on a tray unloader conveyor line 38 comprising a conventional twin belt type. The tray unloader stage 40 which warms and vibrates the loaded trays 20 to cause the squid slices 10 to drop down onto a freezer conveyor line 42.

The loose squid slices 10 are conveyed by the freezer conveyor line 42 to the freezer tunnel 44 maintained at approximately 20° F. for packaging, transportation or long-term storage. The frozen squid slices 10 are packaged in process step 46 as open squid slices in sealed containers selected from the group consisting of a paper box and a plastic bag (not shown).

The emptied and soiled molds 14 are recycled after cleaning as shown in the FIG. 2 stage back to the FIG. 1 squid slice freezing and packaging stage. The molds 14 and trays 20 are transferred by a washer conveyor line in block 46 to the washing and sanitizing stage 48 in a washer machine. The cleaned molds 14 and trays 20 are transferred to and stacked on a tray cart 22 in stage 50 and moved to the load conveyor line 26 in stage 52. The tray carts 22 are unloaded in stage 54 and the molds 14 placed on the load conveyor line 26 in stage 56.

Alternatively, bulk frozen squid bodies or tubes which have been cleaned, skinned, dewinged, and bulk frozen in foreign countries at a lower labor cost can be thawed and prepared as fresh squid rings. Blanched squid rings can be utilized in the present invention, but result in decreased product quality. Therefore, the present invention offers the consumer much lower costs in obtaining better flavor and texture than can be found in Calamari squid rings produced from bulk-frozen squids.

It is to be understood that the present invention is not limited to the sole embodiment described above, but encompasses any and all embodiments within the scope of the following claims.

We claim:

1. A process of manufacturing packages of freshly frozen Calimari squid rings comprising:
placing fresh flattened Calamari squid slices on molds having a pin to open up the squid slices;
freezing the open squid slices on the molds at 5-15° F.;
removing the frozen open squid slices from the molds;
refreezing the open squid slices at about 20° F.; and
packaging the open squid slices in sealed containers selected from the group consisting of a paper box and a plastic bag.

2. The manufacturing process according to claim 1, wherein the molds have a centered and tapered vertical male pin for mounting the squid slices in an open condition for freezing.

3. The manufacturing process according to claim 1, wherein the freezing step at 5-15° F. is conducted in a prefreezer tunnel.

4. The manufacturing process according to claim 1, wherein liquid nitrogen is added to freeze the open squid slices on molds.

5. The manufacturing process according to claim 1, wherein the removing step is initially performed by inverting the mold tray and transferring to a tray unloader conveyor.

6. The manufacturing process according to claim 5, further warming the inverted molds to release the frozen open squid slices.

7. The manufacturing process according to claim 6, further transferring the released frozen open squid slices to a refreezing conveyor.

8. The manufacturing process according to claim 1, wherein the refreezing step is performed in a freezer tunnel.

9. The manufacturing process according to claim 1, further packaging a quantity of the refrozen open squid slices in a paper box which is sealed.

10. The manufacturing process according to claim 1, further packaging a quantity of the refrozen open squid slices in a plastic bag which is sealed.
